(19) United States
(12) Patent Application Publication
(10) Pub. No.: US 2013/0074666 A1
(43) Pub. Date: Mar. 28, 2013

(54) WORKPIECE CUTTING APPARATUS

(71) Applicants: Kenichi Kawada, Yokohama-shi (JP); Hiroki Matsunae, Yokohama-shi (JP); Toshiyuki Suzuki, Yokohama-shi (JP); Akihiro Shijo, Atsugi-shi (JP)

(72) Inventors: Kenichi Kawada, Yokohama-shi (JP); Hiroki Matsunae, Yokohama-shi (JP); Toshiyuki Suzuki, Yokohama-shi (JP); Akihiro Shijo, Atsugi-shi (JP)

(73) Assignee: NISSAN MOTOR CO., LTD., Yokohama, Kanagawa (JP)

(21) Appl. No.: 13/702,962

(22) PCT Filed: Jun. 10, 2011
(86) PCT No.: PCT/IB11/01313

§ 371 Date: Dec. 7, 2012

(30) Foreign Application Priority Data
Jun. 17, 2010 (JP) 2010-138736

(51) Int. Cl. B23D 31/00

(52) U.S. Cl. CPC B23D 31/00
USPC 83/23; 83/145

(57) ABSTRACT

A workpiece cutting apparatus that basically includes a fixed blade, a moving blade and a cleaning component. The fixed blade is configured to fixedly receive a workpiece. The moving blade is moveably mounted relative to the fixed blade, and the moving blade and the fixed blade are arranged relative to each other to shear the workpiece that is fixed relative to the fixed blade. The cleaning component is arranged relative to the moving blade to remove a deposit from the moving blade.

### CROSS-REFERENCE TO RELATED APPLICATIONS

This application claims priority to Japanese Patent Application No. 2010-138736, filed on Jun. 17, 2010. The entire disclosure of Japanese Patent Application No. 2010-138736 is hereby incorporated herein by reference.

### BACKGROUND

1. Field of the Invention

The present invention generally relates to a workpiece cutting apparatus. More particularly, the present invention relates to a workpiece cutting apparatus including a cleaning component which cleans a cutting blade to prevent chips and other debris from depositing on the cutting blade.

1. Background Information

A thin metal foil can be used, for example, as an electrode foil for batteries. In order to form the electrode foil, a press blade can be used to punch out a suitable shape from the thin metal foil. Also, a shear blade can be used to cut a suitable shape from the thin metal foil. For example, a shear blade can be used to cut portions of the thin metal foil that is coated with an active material. On the other hand, a press blade can be used to cut other portions of the thin metal foil. Furthermore, as described in Japanese Laid-Open Patent Publication No. 2006-252805, different blades can be used at the cutting position of a workpiece based on the workpiece structure. The use of different blades can extend the service life of the press blade and the shear blade.

### SUMMARY

As understood in the art, materials such as aluminum, copper and the like are typically used as electrode foil for batteries. Press blades or sheer blades can be used to cut the materials to form the electrode foils. However, there is concern that chips or other debris will be deposited on the press blades or the shear blades when the aluminum, copper, or the like is repeatedly cut. Furthermore, the amount of deposit can slowly increase when repeated cuttings continue to be made after chips or other debris have been deposited. Thus, the clearance between the upper and lower press blades or sheer blades used for cutting eventually increases due to the increased deposits. Accordingly, there is concern that burrs can form on the cut electrode foil when clearance between the upper and lower blades increases, which can degrade the quality of the electrode foil.

Therefore, the cutting equipment can be periodically stopped and the blades can be cleaned during the stopped period to prevent an increase in deposits. However, stopping the cutting equipment can lower production efficiency since no cutting is performed during the stoppage period. Japanese Laid-Open Patent Publication No. 2006-252805 fails to sufficiently address this issue.

Accordingly, an object of the present invention is to prevent or at least reduce the formation of deposits as discussed above.

In view of the state of the known technology, one aspect of the present invention is to provide a workpiece cutting apparatus that basically includes a fixed blade, a moving blade and a cleaning component. The fixed blade is configured to fixedly receive a workpiece. The moving blade is moveably mounted relative to the fixed blade, and the moving blade and the fixed blade are arranged relative to each other to shear the workpiece that is fixed relative to the fixed blade. The cleaning component is arranged relative to the moving blade to remove a deposit from the moving blade.

### BRIEF DESCRIPTION OF THE DRAWINGS

Referring now to the attached drawings which form a part of this original disclosure:

FIG. 1A is a perspective view of a shearing apparatus in accordance with one illustrated embodiment;

FIG. 1B is another perspective view of the shearing apparatus in accordance with one illustrated embodiment;

FIG. 2 is a compound cross-sectional view of the shearing apparatus illustrated in FIGS. 1 and 2 as viewed along section line 2-2 in FIG. 1B;

FIGS. 3A through 3F illustrate a sequence of simplified diagrammatic views showing an example of the cutting operation of the shearing apparatus according to a first embodiment, with the view of FIG. 3F being a partial enlarged view of the view of FIG. 3C;

FIG. 4 is an enlarged simplified diagrammatic view of a cutting area of the shearing apparatus that illustrates the mechanism of shearing-based cutting; and

FIGS. 5A through 5D illustrate a sequence of simplified diagrammatic views showing the cutting operation of the shearing apparatus according to a second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

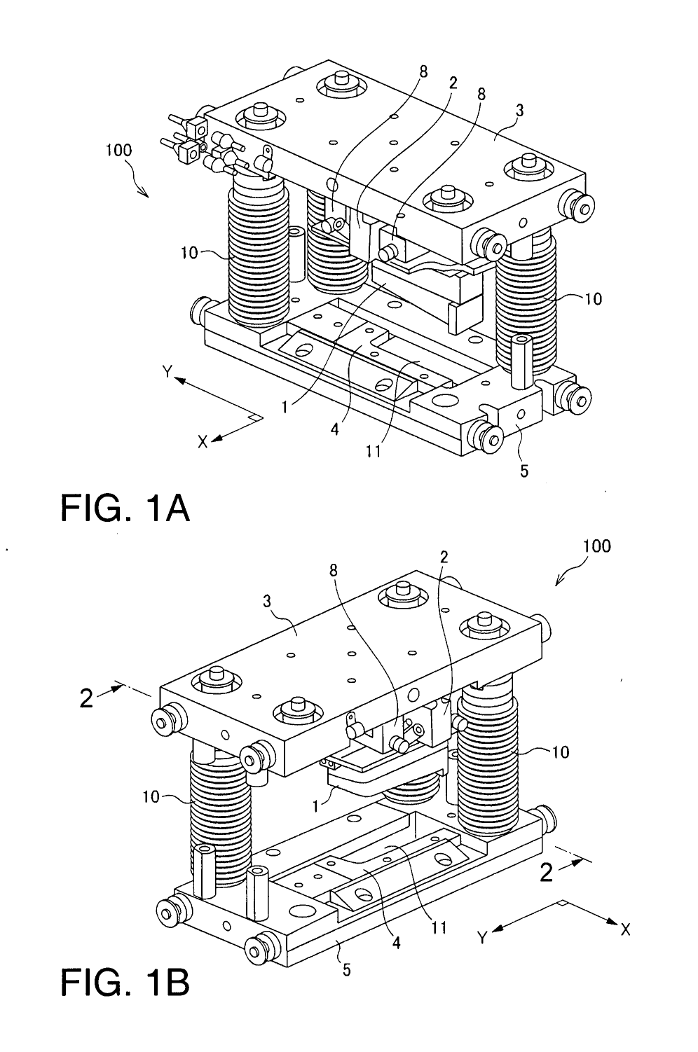

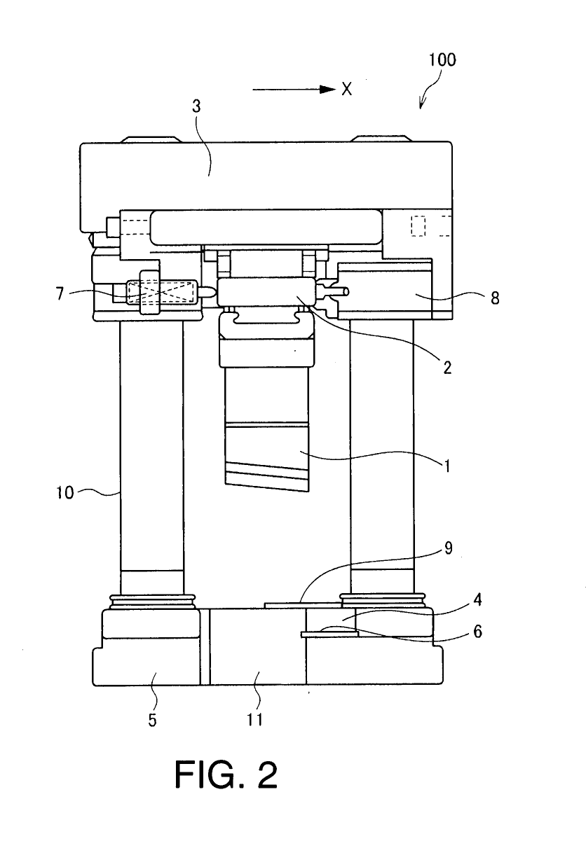

Referring initially to FIGS. 1A, 1B and 2, an overall configuration of a shearing apparatus 100 is illustrated in accordance with a first embodiment. FIGS. 1A and 1B are perspective views seen from different directions. FIG. 2 is a compound cross-sectional view of the shearing apparatus 100 as viewed along section line 2-2 in FIG. 1B.

The shearing apparatus 100 basically includes, among other things, an upper blade 1, a moveable unit 2, an upper plate 3, a lower blade 4, a lower plate 5, a cleaning tool 6 (cleaning component), and a plunger 7 and an actuator 8. The upper plate 3 is moved up and down by the actuator 8 of a press machine, or the like, along guide cylinders 10. The cylinder on the near side of the drawings is omitted in FIGS. 1A and 1B. Thus, one of the guide cylinders 10 is disposed in each of the four corners of the lower plate 5.

The lower blade 4 is fixed to the lower plate 5. The upper blade 1 (moving blade or cutting blade) is mounted on the upper plate 3 via the moveable unit 2. The upper blade 1 can be formed of steel, carbide, or the like, or any other suitable material. FIGS. 1A and 1B show a so-called L-shaped blade. However, the upper blade 1 can be a straight blade or a crank blade, or have any other suitable blade configuration.

The lower plate 5 is formed in a relief part 11. The relief part 11 allows the upper blade 1 to pass through at least an upper surface of the lower plate 5. A workpiece 9 can be fixed on top of the lower blade 4 so as to extend above the relief part 11. The cleaning tool 6 in this example is fixed below the lower blade 4 along the shape of the lower blade 4. Examples of items that can be used for the cleaning tool 6 include sheet-shaped elastic bodies formed of resin or the like, resin or metal brushes, and other suitable items and materials. The amount by which the lower blade 4 extends above the relief part 11 is set at about the thickness of the cleaning tool 6 for reasons described below.

The moveable unit 2 is mounted to the lower surface of the upper plate 3 so as to be able to move along a rail, groove, or the like. In this arrangement, the moveable unit 2 can move on x and y axes within a plane orthogonal or substantially orthogonal to the direction of the vertical movement of the upper plate 3. In this example, the x-axis is the direction along the short side of the L-shaped blade, and the y-axis is the direction along the long side, as shown in FIG. 1A.

The plunger 7 is used to apply a constant or substantially constant pressing force to the moveable unit 2 on the x and y axes in the direction toward the lower blade 4. As referred to herein, the pressing force can be the elastic force of an elastic body such as a spring.

In contrast, the actuator 8 can subject the moveable unit 2 to a pressing force sufficient for the unit to move away from the lower blade 4 against the pressing force of the plunger 7. For example, an air cylinder or the like can be used as the actuator.

Movement on the x-axis is sufficient in the case of a straight blade. Also, the plunger 7 and the actuator 8 are unnecessary to cause a pressing force to act in the direction of the y-axis. Moreover, any arrangement should be sufficient as long as a pressing force can be caused to act toward the direction of the x-axis.

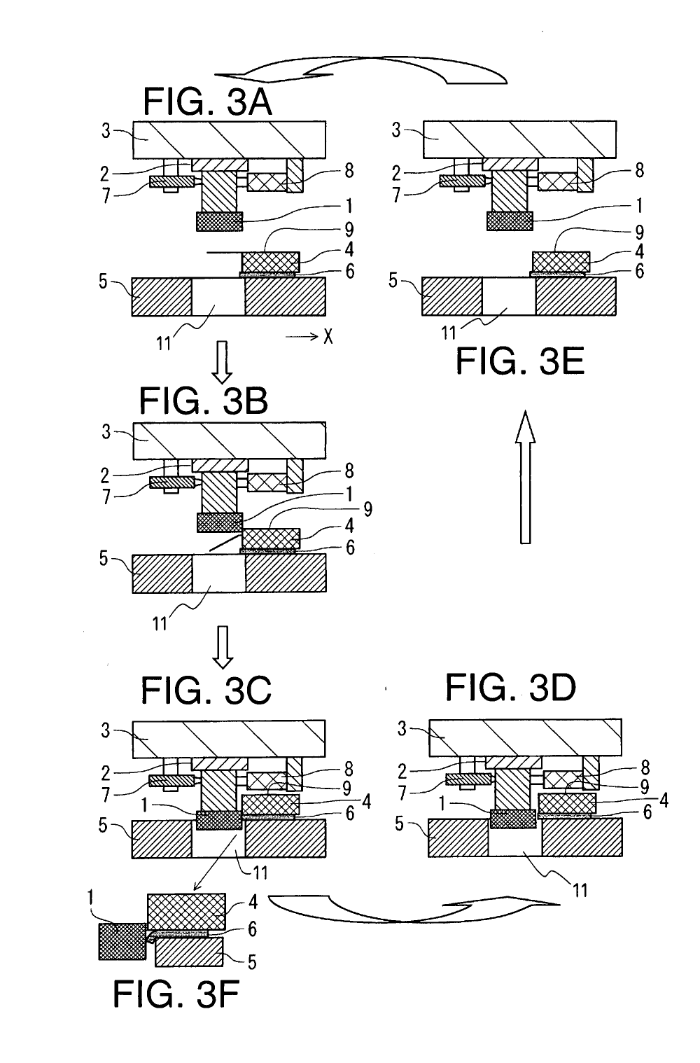

An example of the operation of the shearing apparatus 100 will now be described with reference to FIGS. 2 and 3A through 3F. That is, FIGS. 3A through 3F are simplified versions of the same cross-sectional view along line 2-2 in FIG. 1B as in FIG. 2. Furthermore, FIGS. 3A through 3F illustrate a sequence of simplified diagrammatic views showing an example of a single cycle of a workpiece cutting operation. Furthermore, FIG. 3F illustrates an enlargement of the area in proximity to the cleaning tool 6 as shown in FIG. 3C.

FIG. 3A represents the initial position before the cutting operation begins. In this position, the plunger 7 applies pressure to the moveable unit 2 in the direction of the x-axis and, more specifically, in the direction of the actuator 8. No pressure is generated by the actuator 8 on the other side. The workpiece 9 is fixed on top of the lower blade 4 so as to extend above the relief part 11.

From this position, the upper plate 3 is pressed downward by a press machine or the like. Thus, the upper blade 1 is lowered. The workpiece 9 is cut by the overlapping of the upper blade 1 and the lower blade 4, as shown in view FIG. 3B. The cut workpiece 9 falls into the relief part 11. Force in the direction away from the lower blade 4 acts on the upper blade 1 from the workpiece 9 during cutting. However, the clearance between the upper blade 1 and the lower blade 4 is maintained because pressure continues to be applied to the upper blade 1 in the direction of the lower blade 4 by the plunger 7.

As shown in FIG. 3C, the upper blade 1 continues to descend even after the workpiece 9 is cut. Accordingly, the cleaning tool 6 rubs against the lateral surface of the upper blade 1 in contact with the workpiece 9 during the cutting operation. At this time, pressure is applied to the upper blade 1 by the plunger 7 (elastic force application component) in the direction of the cleaning tool 6.

The amount by which the lower blade 4 extends above the relief part 11 is set at about the thickness of the cleaning tool 6, as described above. There is thus a clearance about the size of the thickness of the cleaning tool 6 between the lateral surface of the upper blade 1 and the wall surface of the relief part 11 when the upper blade 1 descends to the position of the lower plate 5. The cleaning tool 6 is a readily deformable tool such as a resin elastic body or a brush, or any other suitable type of material.

Accordingly, the cleaning tool 6 bends in the descent direction of the upper blade 1 and rubs against the lateral surface of the upper blade 1 without being cut, even when the upper blade 1 descends and comes into contact with the cleaning tool 6, as shown in view FIG. 3F. Also, even when the clearance between the lateral surface of the upper blade 1 and the wall surface of the relief part 11 is smaller than the thickness of the cleaning tool 6, and the impact of the cleaning tool 6 coming into contact with the upper blade 1 exceeds the pressing force of the plunger 7, the impact will be absorbed by the compression and movement of the spring of the plunger 7. Specifically, the impact will be absorbed in the direction in which the upper blade 1 moves away from the cleaning tool 6. This can therefore eliminate or at least reduce damage to and early deterioration of the cleaning tool 6.

Once the upper blade 1 reaches the lower dead point, the actuator 8 is actuated to move the upper blade 1 against the pressing force of the plunger 7 and away from the lower blade 4 and the cleaning tool 6, as shown in FIG. 3D. Also, since the upper blade 1 no longer contacts the cleaning tool 6, the cleaning tool 6 returns to its initial state

The upper plate 3 is thus returned to the upper dead point, that is, the initial position, by the press machine or the like, as shown in FIG. 3E. In this example, the upper blade 1 does not come into contact with the lower blade 4 and the cleaning tool 6 when moving upward because the upper blade 1 is raised after being moved away from the lower blade 4 and the cleaning tool 6. This can prevent chips and other debris that are attached to the lower blade 4 or the cleaning tool 6 from being dispersed by contact with the upper blade 1.

The above-described process represents a single cycle of a shearing operation of the shearing apparatus 100. The time required for a single cycle may be, for example, about three seconds or any other suitable amount of time.

Accordingly, as can be appreciated from the above, the cleaning tool 6 in the shearing apparatus 100 is fixed so as to extend a considerable distance toward the relief part 11 beyond the lower blade 4. The cleaning tool 6 therefore rubs against the upper blade 1 after the workpiece 9 is cut during each stroke. Thus, the cleaning tool 6 cleans the lateral surface of the upper blade 1. This cleaning prevents chips or the like from depositing on the upper blade 1 by the cutting of the workpiece 9. Clearance between the upper blade 1 and the lower blade 4 can therefore be maintained, and loss of quality due to the formation of deposits can be avoided.

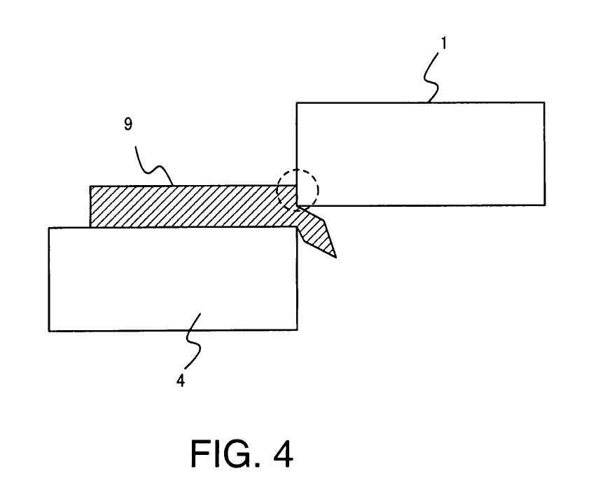

In addition, FIG. 4 is an enlarged view showing an example of the area in the proximity of the cutting area to illustrate the cutting mechanism of the shearing apparatus 100. As shown, the upper blade 1 cuts into the workpiece 9. The workpiece 9 thus rubs against the lateral surface of the upper blade 1 when the workpiece 9 fixed on top of the lower blade 4 is cut, as shown by the dashed circle in the drawing. In contrast, there is substantially no rubbing of the workpiece 9 against the lateral surface of the lower blade 4.

Furthermore, debris is generally deposit by the mutual rubbing of materials having high affinity for each other. This phenomenon may occur in a single rubbing operation or in several rubbing operations. The deposits may form more readily when aluminum or another material is used as the workpiece 9 to form the electrode foil because of the high affinity with the upper blade 1 that is usually formed of steel, carbide, or the like. Also, the deposits typically do not form in a single cutting. Rather, the deposits may from after at least four, five, or more cuttings.

Also, if cutting is performed repeatedly without attaching the cleaning tool 6, the debris deposits on the upper blade 1 can grown in size and possibly reach the lower blade 4. Thus, debris can become deposited on the lower blade 4 at a location corresponding to the area where the debris deposited on the upper blade 1 contacts the lower blade 4. In other words, the deposits on the lower blade 4 can be material that is transferred from the deposits on the upper blade 1. Also, this transfer of deposits to the lower blade 4 typically occurs after the deposits on the upper blade 1 have grown in size.

Accordingly, cleaning the lateral surface of the upper blade 1 using the cleaning tool 6 on every stroke, as with the shearing apparatus 100, can prevent or at least reduce the formation of deposits on the upper blade 1. This can also prevent or at least reduce the transfer of the deposits to the lower blade 4. Also, even when minute deposits have formed on the upper blade 1, the deposits can be prevented from growing in size because the blade is cleaned on every stroke. Hence, it is unlikely that the clearance between the upper blade 1 and the lower blade 4 will decrease or that other conditions which adversely affect the cutting performance will occur. In addition, the deposits are typically not transferred to the lower blade 4 because the deposits on the upper blade 1 can be prevented from growing in size.

Accordingly, cleaning only the upper blade 1 is sufficient to prevent the formation and growth of deposits. Preventing deposits from growing on the upper blade 1 also prevents such deposits to be prevented from growing on the lower blade 4 because the deposits on the lower blade 4 are typically transferred from the deposits on the upper blade 1. As a result, clearance between the upper blade 1 and the lower blade 4 can be maintained, which can also prevent or at least reduce the formation of burrs on the cutting surface.

As can further be appreciated from the above, deposits can be immediately removed even when formed during cutting because the cleaning tool 6 rubs against the upper blade 1 after the workpiece 9 is cut. In addition, the cleaning operation has little or no effect on the cutting operation. The cleaning tool 6 is disposed on the side of the lower blade 4 opposite the side to which the workpiece 9 is fixed so as to extend on a trajectory in which the upper blade 1 moves away from the lower blade 4. The cleaning tool 6 therefore reliably rubs against the upper blade 1 after the workpiece is cut, making it possible to prevent or at least reduce the formation of deposits.

Furthermore, the plunger 7 applies an elastic force to the upper blade 1 in the direction of the cleaning tool 6 at least during rubbing against the cleaning tool 6. This enables the upper blade 1 to move in a direction away from the cleaning tool 6 when the cleaning tool 6 comes into contact with the upper blade 1. The impact during contact of the cleaning tool 6 with the upper blade 1 is therefore mitigated, which prevents early deterioration of the cleaning tool 6.

Also, the upper blade 1 and the cleaning tool 6 rub against each other while the upper blade 1 continues to move in the same direction after the workpiece 9 is cut. The upper blade 1 is therefore cleaned every cycle, making it possible to reliably prevent the formation of deposits.

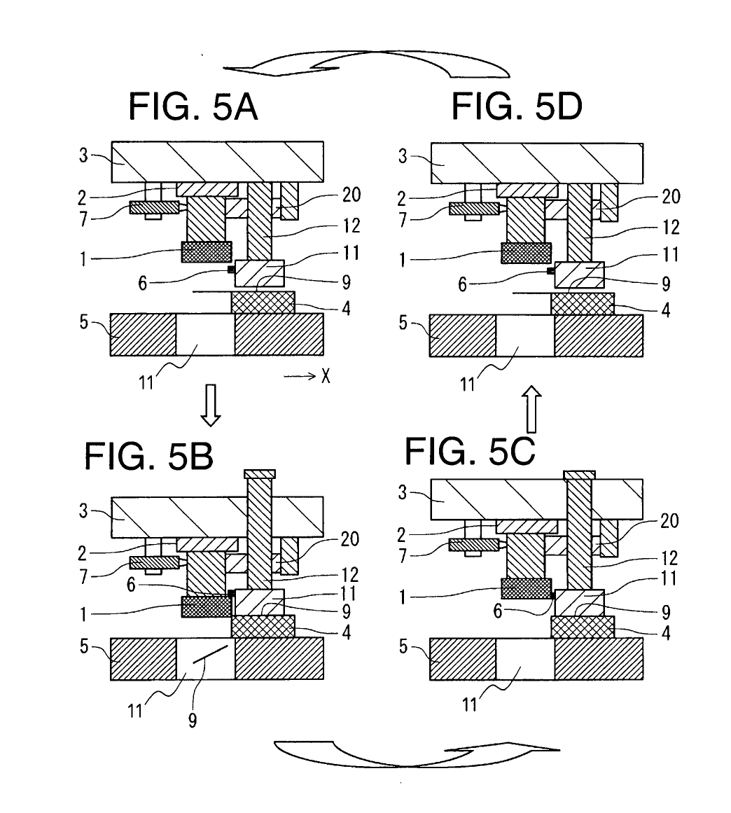

FIGS. 5A through 5D illustrate a sequence of simplified diagrammatic views showing a single cycle of the workpiece cutting operation according to a second disclosed embodiment. In view of the similarity between the first and second embodiments, the parts of this second embodiment that are identical to the parts of the first embodiment will be given the same reference numerals as the parts of the first embodiment. Moreover, the descriptions of the parts of the second embodiment that are identical or substantially identical to the parts of the first embodiment may be omitted for the sake of brevity.

As shown in FIGS. 5A through 5D, the shearing apparatus includes a stopper 20 instead of the actuator 8 as discussed above. The stopper 20 need not include a mechanism for moving the moveable unit 2 against the pressing force of the plunger 7 as with the actuator 8. Rather, the stopper 20 limits the movement of the moveable unit 2 in the direction of the x axis.

The cleaning tool 6 is attached to a plate 11, which is itself attached to a pin 12. Thus, the cleaning tool 6 extends above the relief part 11 beyond the lower blade 4. The pin 12 is attached to a press machine or the like to be able to slide on the upper plate 3. Specifically, the pin 12 does not move or substantially does not move even when the upper plate 3 is raised. Accordingly, the location of the cleaning tool 6 does not change or substantially does not change.

In the shearing apparatus shown in FIGS. 5A though 5D, the lateral surface of the upper blade 1 rubs against the cleaning tool 6 when the upper blade 1 moves between the initial state shown in FIG. 5A to the state shown in FIG. 5B. In the initial state shown in FIG. 5A, the workpiece 9 is fixed on top of the lower blade 4. In the state shown in FIG. 5B, the workpiece 9 is cut. In the process, the cleaning tool 6 is not cut by the upper blade 1 if a clearance having about the thickness of the cleaning tool 6 is established between the lateral surface of the plate 11 facing the upper blade 1 and the upper blade 1, as in the first embodiment. Also, the impact that occurs when the upper blade 1 and the cleaning tool 6 come into contact with each other is absorbed by the plunger 7.

That is, the plunger 7 absorbs the impact, such that the upper blade 1 moves in the direction away from the lower blade 4. However, once the upper blade 1 moves past the cleaning tool 6, the upper blade 1 is pressed in the direction of the lower blade 4 by the pressing force of the plunger 7 until the blade comes into contact with the stopper 20. This movement of the upper blade 1 does not therefore affect the cutting operation.

The upper plate 3 continues to ascend once the workpiece 9 is cut and the lower dead point has been reached. As shown in FIG. 5C, the upper blade 1 rubs against the cleaning tool 6 until the upper blade 1 reaches the upper dead point as shown in FIG. 5D. Specifically, the upper blade 1 is cleaned by the cleaning tool 6 during the period after cutting and until the return to the initial state.

Thus, the impact during contact is absorbed by the plunger 7, which prevents the cleaning tool 6 from being cut by the upper blade 1 in the same manner when the upper blade 1 rubs against the cleaning tool 6 during ascending as well as descending. Moreover, the control system can be simplified because in this embodiment, there is no actuator 8 to control as discussed in the first embodiment. Also, the formation of deposits can be prevented or at least reduced in the same manner as in the first embodiment. Costs associated with the apparatus can also be reduced due to reduction in the number of parts and simplification of control.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The term “configured” as used herein to describe a component, section or part of a device that is constructed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A workpiece cutting apparatus comprising:
a fixed blade configured to fixedly receive a workpiece;
a moving blade moveably mounted relative to the fixed blade, the moving blade and the fixed blade being arranged relative to each other to shear the workpiece that is fixed relative to the fixed blade; and
a cleaning component arranged relative to the moving blade to remove a deposit from the moving blade, the cleaning component being configured to rub against the moving blade after the workpiece is cut to remove the deposit.

2. The workpiece cutting apparatus according to claim 1, wherein
an elastic force application component configured to apply an elastic force to the moving blade in a direction toward the cleaning component at least while the moving blade rubs against the cleaning component.

3. The workpiece cutting apparatus according to claim 1, wherein
the cleaning component is disposed on a side of the fixed blade opposite a side to which the workpiece is fixed, to extend within a trajectory in which the moving blade moves away from the fixed blade.

4. The workpiece cutting apparatus according to claim 3, further comprising
an elastic force application component configured to apply an elastic force to the moving blade in a direction toward the cleaning component at least while the moving blade rubs against the cleaning component.

5. A method for cleaning a cutting blade of a workpiece cutting apparatus comprising:
moving the cutting blade relative to a fixed blade on which a workpiece is fixed to cut the workpiece; and
placing the cutting blade and a cleaning component in contact with each other to cause the cleaning component to remove a deposit on the cutting blade while imposing an elastic force on the cutting blade in a direction of the cleaning tool after the workpiece is cut.

6. The cutting blade cleaning method according to claim 5, wherein
the placing of the cutting blade and the cleaning component in contact with each other includes rubbing the cutting blade and the cleaning component against each other during a period of time after the workpiece is cut and until the cutting blade returns to an initial position at which the cutting blade was positioned prior to cutting the workpiece.

7. The cutting blade cleaning method according to claim 6, wherein
the placing of the cutting blade and the cleaning component in contact with each other includes rubbing the cutting blade and the cleaning component against each other after the workpiece is cut and while the cutting blade continues to move in a cutting direction.
